(19) United States
(12) Patent Application Publication
(10) Pub. No.: US 2025/0298191 A1
(43) Pub. Date: Sep. 25, 2025

(54) HYBRID NANOPHOTONIC WAVEGUIDES FOR ENHANCED SECOND ORDER NONLINEAR CONVERSION EFFICIENCY

(71) Applicant: Honeywell International Inc., Charlotte, NC (US)

(72) Inventors: Wei Charles Jiang, Vestal, NY (US); Matthew Wade Puckett, Phoenix, AZ (US); Chad Fertig, Roseville, MN (US); Jad Salman, Wayzata, MN (US); Steven Tin, Edina, MN (US)

(73) Assignee: Honeywell International Inc., Charlotte, NC (US)

(21) Appl. No.: 18/610,011

(22) Filed: Mar. 19, 2024

(51) Int. Cl. G02B 6/30

(52) U.S. Cl. CPC G02B 6/305

(57) ABSTRACT

In some examples, a hybrid waveguide is described herein. The hybrid waveguide comprises a waveguide core and a cladding material surrounding the waveguide core. The waveguide core includes a first optical waveguide layer that is formed from a χ⁽²⁾ nonlinear optical material. The waveguide core also includes a second optical waveguide layer disposed on top of the first optical waveguide layer. The second optical waveguide layer is formed of a non-χ⁽²⁾ optical material. A width of the first optical waveguide layer is substantially equal to a width of the second optical waveguide layer, and an index of refraction of the first optical waveguide layer is within fifteen percent of an index of refraction of the second optical waveguide layer.

### BACKGROUND

On-chip nonlinear photonics via second-order χ⁽²⁾ nonlinearity has found various applications such as, for example, optical communications, frequency metrology, sensing and spectroscopy, and quantum information processing. To ensure an efficient second-order parametric process, phase matching among the interacting optical waves must be fulfilled. To date, domain engineering of nonlinear susceptibility and modal index engineering (MIE) are the two main approaches to realize phase matching. An example of domain engineering is periodic poling, which can achieve efficient quasi-phase matching, but periodic poling can only be applied to ferroelectric or III-V semiconductor materials. Furthermore, it becomes very challenging to maintain domain uniformity for applications at visible wavelengths which require tiny domain periods. On the other hand, MIE is a prominent approach to match the modal indices between the higher-order modes at shorter wavelengths and the fundamental mode at longer wavelengths. Although MIE has no material limitation, it generally suffers from significant mode field mismatch (for example, very low modal overlap among the interacting higher-order modes and fundamental mode in a conventional homogeneous χ⁽²⁾ waveguide), which results in seriously reduced nonlinear conversion efficiency. Moreover, for on-chip nonlinear photonic applications, particularly in the quantum regime, efficient fiber-to-chip coupling for both the fundamental mode and higher-order modes is also critical to the overall efficiency. For the homogeneous χ⁽²⁾ nanophotonic waveguides, the constraint of waveguide geometry for phase matching could make it very challenging to realize an efficient fiber-to-chip scheme without adding too much complexity in design and fabrication, particularly for applications at visible wavelengths, due to the significant contrast between the mode field sizes of the waveguide and optical fiber.

For the reasons above, and for other reasons discussed herein, there is a need for improved components for integrated photonics chips that provide desired phase matching and efficiency for χ⁽²⁾ nonlinear processes while also reducing complexity in design and fabrication across applications at various wavelengths.

### SUMMARY

In some aspects, a system is described herein. The system comprises a hybrid waveguide including a first optical waveguide layer and a second optical waveguide layer. The first optical waveguide layer is formed of a χ⁽²⁾ nonlinear optical material, and the second optical waveguide layer is formed of a non-χ⁽²⁾ optical material. A width of the first optical waveguide layer is substantially equal to a width of the second optical waveguide layer, and an index of refraction of the first optical waveguide layer is within fifteen percent of an index of refraction of the second optical waveguide layer. The system further comprises an edge coupler, a spot size converter, and/or a mode converter. The edge coupler is configured to be optically coupled to an optical fiber and match a mode field size of the optical fiber and includes at least the first optical waveguide layer. The first optical waveguide layer is tapered. The spot size converter is configured to convert between an optical mode size of the hybrid waveguide and the optical mode size of the optical fiber or an optical mode size of the edge coupler. The spot size converter includes both the first optical waveguide layer and the second optical waveguide layer, and the second optical waveguide layer is tapered. The mode converter is configured to convert between a first optical mode and a second optical mode. The mode converter includes a first section with only the first optical waveguide layer and a second section with the first optical waveguide layer and the second optical waveguide layer, wherein the first section is proximate the second section.

In some aspect, a hybrid waveguide is described herein. The hybrid waveguide comprises a waveguide core and a cladding material surrounding the waveguide core. The waveguide core includes a first optical waveguide layer that is formed from a χ⁽²⁾ nonlinear optical material. The waveguide core also includes a second optical waveguide layer disposed on top of the first optical waveguide layer. The second optical waveguide layer is formed of a non-χ⁽²⁾ optical material. A width of the first optical waveguide layer is substantially equal to a width of the second optical waveguide layer, and an index of refraction of the first optical waveguide layer is within fifteen percent of an index of refraction of the second optical waveguide layer.

In some aspects, a component of an integrated photonics chip is described herein. The component of the integrated photonics chip comprises a first optical waveguide layer and a second optical waveguide layer disposed on top of the first optical waveguide layer. The first optical waveguide layer is formed from a χ⁽²⁾ nonlinear optical material, and the second optical waveguide layer is formed of a non-χ⁽²⁾ optical material. A width of the first optical waveguide layer is substantially equal to a width of the second optical waveguide layer for at least a first portion of a length of the component, and an index of refraction of the first optical waveguide layer is within fifteen percent of an index of refraction of the second optical waveguide layer.

### BRIEF DESCRIPTION OF THE DRAWINGS

Understanding that the drawings depict only some embodiments and are not therefore to be considered limiting in scope, the exemplary embodiments will be described with additional specificity and detail using the accompanying drawings, in which:

FIG. 1 is a diagram of an example hybrid waveguide;

FIG. 2A is a diagram of an example mode profile of a fundamental mode;

FIG. 2B is a diagram of an example mode profile of a higher-order mode;

FIG. 3A is a diagram showing a cross-section of a tip of an example edge coupler, a mode profile for the tip of the edge coupler, and a graph of coupling efficiency for various tip widths of the edge coupler;

FIG. 3B is a diagram showing a cross-section of a tip of another example edge coupler, a mode profile for the tip of the edge coupler, and graphs of coupling efficiency for various tip widths and thicknesses of the edge coupler;

FIG. 4 is a diagram of an example spot size converter;

FIGS. 5A-5D are diagrams of example mode profiles associated with the spot size converter in FIG. 4;

FIG. 6 is a diagram of an example mode converter;

FIGS. 7A-7D are diagrams of example mode profiles associated with the mode converter in FIG. 6;

FIGS. 8A-8G is a method flow an example method of manufacture of a system including a spot size converter, a mode converter, and a hybrid waveguide.

In accordance with common practice, the various described features are not drawn to scale but are drawn to emphasize specific features relevant to the example embodiments.

### DETAILED DESCRIPTION

In the following detailed description, reference is made to the accompanying drawings that form a part hereof, and in which are shown by way of illustration specific illustrative embodiments. However, it is to be understood that other embodiments may be utilized, and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

The techniques described herein propose a hybrid waveguide structure that includes a first optical waveguide layer and a second optical waveguide layer disposed on top of the first waveguide layer. The first and second optical waveguide layers have substantially the same width and the index of refraction for the first and second optical waveguide layers is within about fifteen percent of each other. The first optical waveguide layer is formed from a χ⁽²⁾ nonlinear optical material, and the second optical waveguide layer is formed from a non-χ⁽²⁾ optical material. In some examples, the first optical waveguide layer is formed from lithium niobate, aluminum nitride, or a III-V semiconductor material, and the second optical waveguide layer is formed from silicon nitride, tantalum pentoxide, or titanium oxide. The hybrid waveguide structure and other components of an integrated photonics chip discussed herein provide desired intermodal phase matching and efficiency for χ⁽²⁾ nonlinear optical processes over a broad range of wavelengths without adding complexity to design and fabrication.

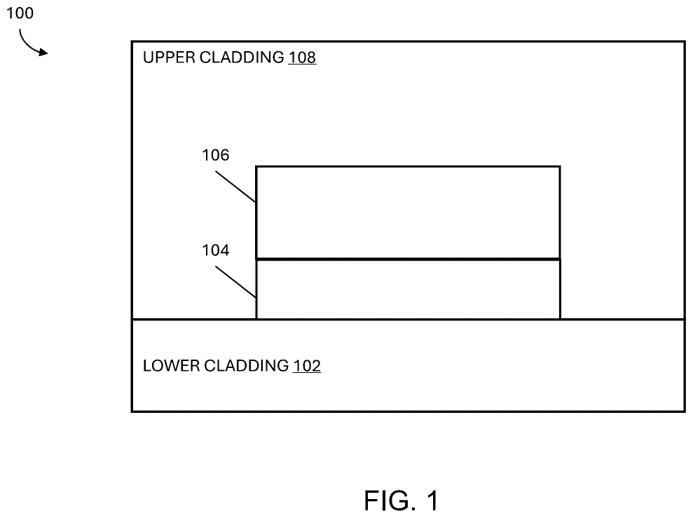

FIG. 1 is a diagram of an example hybrid waveguide 100. In the example shown in FIG. 1, the hybrid waveguide 100 includes a lower cladding 102, a first optical waveguide layer 104, a second optical waveguide layer 106, and an upper cladding 108. The second optical waveguide layer 106 is positioned on top of the first optical waveguide layer 104, and the first optical waveguide layer 104 and the second optical waveguide layer 106 together form the core of the hybrid waveguide 100.

In the examples described herein, the first optical waveguide layer 104 is a χ⁽²⁾ nonlinear optical material configured to be use for χ⁽²⁾ nonlinear optical processes. In some examples, the first optical waveguide layer 104 is specifically described with respect to second-harmonic generation (SHG) and the material of the first optical waveguide layer 104 is referred to as being a χ⁽²⁾ material. It should be understood that the first optical waveguide layer 104 could also be configured for other nonlinear optical processes as well.

In some examples, the material for the first optical waveguide layer 104 is lithium niobate (LN). In some such examples, the material for the first optical waveguide layer 104 is thin film lithium niobate (TFLN), for example, x-cut TFLN. In other examples, the material for the first optical waveguide layer 104 is a III-V semiconductor material. Lithium niobate and III-V semiconductor materials have relatively mature wafer technology and fabrication processes that would enable easier fabrication of the hybrid waveguide 100. In some examples, other χ⁽²⁾ nonlinear optical materials (for example, aluminum nitride) could also be used besides lithium niobate and III-V semiconductor materials, but these may introduce some difficulties in manufacturing compared to thin film lithium niobate and III-V semiconductor materials depending on the material.

The second optical waveguide layer 106 is a different material than the first optical waveguide layer 104, which gives the hybrid waveguide 100 a heterogeneous structure. In general, there are more materials suitable for use for the second optical waveguide layer 106 compared to materials suitable for use for the first optical waveguide layer 104. In the examples described herein, the second optical waveguide layer 106 is a non-χ⁽²⁾ optical material. In some such examples, the second optical waveguide layer 106 is a non-χ⁽²⁾ linear optical material. The particular material for the second optical waveguide layer 106 is selected based on the χ⁽²⁾ nonlinear optical material used for the first optical waveguide layer 104 such that the material for the second optical waveguide layer 106 has a refractive index that is in close proximity to the refractive index of the first optical waveguide layer 104 in order to provide sufficient optical mode confinement. In some examples, the refractive index of the second optical waveguide layer 106 is within 15% of the refractive index of the first optical waveguide layer 104. In some examples, the refractive index of the second optical waveguide layer 106 is within 10% of the refractive index of the first optical waveguide layer 104. Further, in some examples, the material for the second optical waveguide layer 106 is selected based on whether it can be grown or deposited on the material for the first optical waveguide layer 104.

In some examples, the material for the second optical waveguide layer 106 is silicon nitride (SiN). SiN is a particularly good candidate because it is popular for integrated photonics waveguide applications, it is CMOS compatible, its fabrication process is mature, and it has relatively good optical properties including low optical loss. In other examples, the material for the second optical waveguide layer 106 is tantalum pentoxide, titanium oxide, or another non-χ⁽²⁾ optical material that has a refractive index in close proximity (for example, within 10-15%) of the refractive index of the material for the first optical waveguide layer 104. Also, depending on the particular material, the use of other non-χ⁽²⁾ optical materials besides SiN may introduce some difficulties in manufacturing compared to SiN.

The lower cladding 102 and the upper cladding 108 surround the first optical waveguide layer 104 and the second optical waveguide layer 106. In some examples, the lower cladding 102 and the upper cladding 108 are the same material. In other examples, the lower cladding 102 and the upper cladding 108 are different materials. In any case, the cladding material needs to have a low enough refractive index to form index contrast sufficient for a waveguide structure. In some examples, the material for the lower cladding 102 and the upper cladding 108 is silicon dioxide. In other examples, the material for the lower cladding 102 and the upper cladding 108 is air, a polymer material, or other material having a sufficiently low refractive index.

In addition to the selecting the materials for the first optical waveguide layer 104 and the second optical waveguide layer 106, the dimensions of the first optical waveguide layer 104 and the second optical waveguide layer 106 are also selected. The dimensions of the first optical waveguide layer 104 and the second optical waveguide layer 106 are generally selected based on a number of factors including the material, phase matching condition, refractive index, and/or modal index. In some examples, the dimensions of the first optical waveguide layer 104 and the second optical waveguide layer 106 of the waveguide core are selected based on a parametric sweeping of different thicknesses and widths. In some such examples, the thickness and width of the first optical waveguide layer 104 and the second optical waveguide layer 106 are selected to be values that correspond to a desired amount of phase matching and efficiency. In some examples, the thickness and width of the first optical waveguide layer 104 and the second optical waveguide layer 106 are selected to be values that correspond to a maximum amount of phase matching and efficiency. In the example shown in FIG. 1, the width of the first optical waveguide layer 104 and the width of the second optical waveguide layer 106 are substantially equal over the length of the hybrid waveguide 100. It should be understood that substantially equal in this context can allow for slight variation in width between the first optical waveguide layer 104 and the second optical waveguide layer 106 due to, for example, imperfections in the fabrication process.

In one particular example, the hybrid waveguide 100 shown in FIG. 1 is designed for highly efficient SHG at 480 nm with an optical pump at 960 nm. In this particular example, the material for the first optical waveguide layer 104 is lithium niobate, the material for the second optical waveguide layer 106 is SiN, and the material for the lower cladding 102 and the upper cladding 108 is silicon dioxide. In this particular example, the first optical waveguide layer 104 thickness is 60 nm, the second optical waveguide layer 106 thickness is 180 nm, and the width of the first optical waveguide layer 104 and the second optical waveguide layer 106 is 410 nm. The refractive indices of the lithium niobate and SiN are in close enough proximity, for example, ordinary and extraordinary refractive index of lithium niobate are 2.3542 and 2.2599, respectively, and the refractive index of SiN is 2.0688 for 480 nm wavelength.

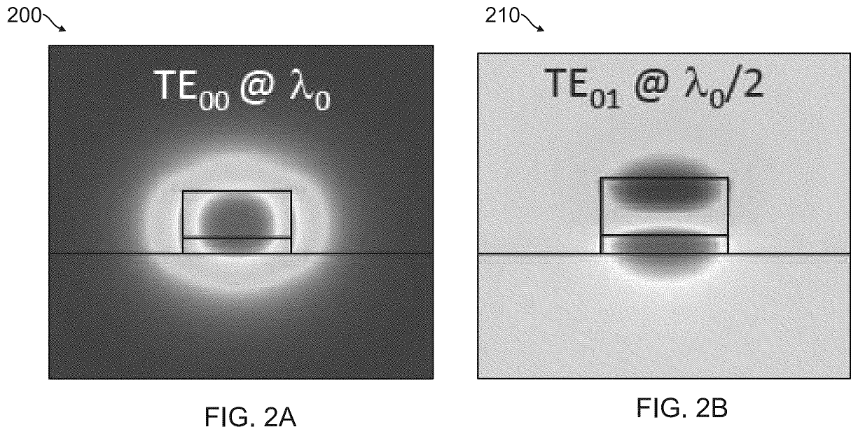

A benefit of the design of the hybrid waveguide 100 is that it can achieve good matching of the modal indices between the fundamental mode at a longer wavelength and the higher-order modes with multiple nodes along the vertical axis at shorter wavelengths. The fundamental mode and higher-order modes have the same polarization, which is commonly called transverse electric (TE) or transverse magnetic (TM) modes. For practical implementation, the TE01 or TM01 mode is adopted for the shorter wavelength, which is the lowest higher-order mode along the vertical axis. With proper design of the thickness of each layer and the waveguide width, the modal index matching between the fundamental mode (for example, TE00 or TM00) and the higher-order mode (for example, TE01 or TM01) is satisfied as can be seen at 200, 210 in FIGS. 2A-2B, respectively. Meanwhile, for the higher-order mode with two opposite field polarities, a single polarity lies in each of the layers, respectively, which is shown at 210 in FIG. 2B. Since the second-order parametric process only occurs in the first optical waveguide layer 104, it will not be canceled by the portion of the mode field with the opposite polarity in the second optical waveguide layer 106, which results in a drastically enhanced second-order effect (in contrast to the case of typical homogeneous χ⁽²⁾ waveguides in which strong modal cancellation occurs).

The SHG efficiency of the hybrid waveguide 100 can be calculated using the following formula:

$$η = \frac{8 {π}^{2}}{{ε}_{0} {cn}_{1}^{2} {n}_{2} {λ}^{2}} \frac{{γ}^{2} {d}_{eff}^{2}}{{A}_{eff}}$$

where γ is the spatial mode overlap factor, d_{eff} is the effective nonlinear susceptibility, and A_{eff} is the effective mode area. λ is the fundamental pump wavelength, and n₁ and n₂ are the effective indices of the fundamental frequency and second harmonic modes, respectively. ε₀ and c are the permittivity and the speed of light, respectively. For the particular example discussed above, the calculated SHG efficiency of the hybrid waveguide 100 is 4300% W\hat{ }(−1) cm\hat{ }(−2), which is more than 50 times higher than that of a conventional homogeneous lithium niobate waveguide based on intermodal phase matching.

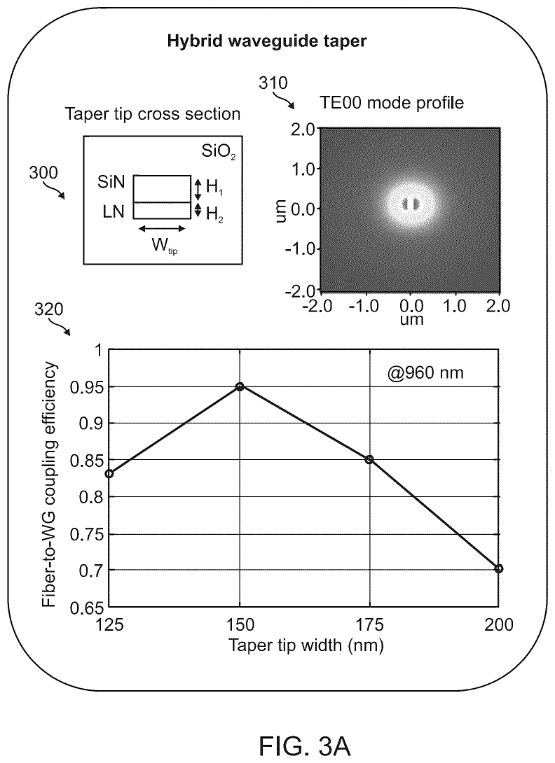

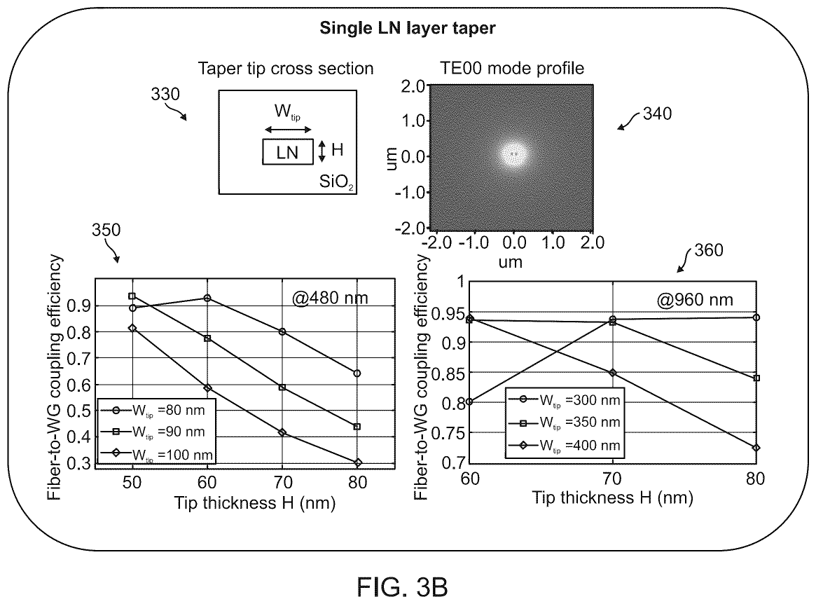

The overall coupling efficiency of an integrated photonics chip that includes the hybrid waveguide 100 is also determined by the efficiency of the other components of the integrated photonics chip such as, for example, an edge coupler, a spot size converter, and/or a mode converter. The edge couplers should be designed to efficiently couple the pump light and the generated signal light into/out of an integrated photonics chip that includes the hybrid waveguide 100. Further, the spot size converter and mode converter should be designed to efficiently couple pump light and generated signal light into/out of the hybrid waveguide 100. Designs for such edge couplers, a spot size converter, and a mode converter are discussed below with respect to FIGS. 3A-7D.

FIGS. 3A-3B illustrate cross-sections of tips of example edge couplers that can be utilized in combination with the hybrid waveguide 100 described above. The edge couplers shown in FIGS. 3A-3B provide very low optical coupling loss to an optical fiber, particularly a single-mode fiber, operating at wavelengths for the fundamental mode and higher-order modes. The edge couplers shown in FIGS. 3A-3B employ an inverse taper design that can be used to adjust the mode confinement, and the tips of the edge couplers are configured to match a mode field size of the optical fiber. In order to achieve high coupling efficiency, good mode overlapping needs to be achieved between the optical fiber and the tip of the edge coupler. The edge coupler 300 described with respect to FIG. 3A is well suited for use with longer wavelengths such as, for example, a wavelength of the fundamental mode (for example, 960 nm). However, the edge coupler 300 may not be suitable for use with shorter wavelengths such as, for example, a wavelength of a higher-order mode (for example, 480 nm) since shorter wavelengths tend to have a more confined and smaller optical mode. The edge coupler 330 described with respect to FIG. 3B is well suited for use with longer wavelengths and shorter wavelengths.

FIG. 3A is a diagram showing a cross-section of the tip of an edge coupler 300. In the example shown in FIG. 3A, the tip of the edge coupler 300 includes a lithium niobate layer (first optical waveguide layer 104) and a silicon nitride layer (second optical waveguide layer 106). In some examples, the edge coupler 300 is a fiber-to-chip edge coupler or a fiber-to-waveguide coupler that is configured to match a mode field size of an optical fiber. In the example shown in FIG. 3A, the mode profile 310 shown is for the fundamental mode (TE00) of the taper tip, which is to match that of a single-mode fiber.

As discussed above, the edge coupler 300 employs an inverse taper such that the width of the first optical waveguide layer 104 and the width second optical waveguide layer 106 is narrowed over a length of the edge coupler 300. In some examples, the width of the first optical waveguide layer 104 and the width of the second optical waveguide layer 106 is narrowed over the entire length of the edge coupler 300. In other examples, the width of the first optical waveguide layer 104 and the width of the second optical waveguide layer 106 is narrowed over less than the entire length of the edge coupler 300. In any case, the width of the first optical waveguide layer 104 and the width of the second optical waveguide layer 106 are tapered equally over the particular length of the edge coupler 300 that is tapered.

At the tip of the edge coupler 300, both the first optical waveguide layer 104 and the second optical waveguide layer 106 are retained and have the same width. The particular dimensions (for example, width) for the tip of the edge coupler 300 can be selected based on parametric sweeping (such as, for example, the parametric sweeping curve 320 shown in FIG. 3A) of different values of the tip width to determine optimal coupling efficiency with an optical fiber. In the example shown in FIG. 3A, the tip width is swept from 125 nm to 200 nm and the peak coupling efficiency is at 150 nm for a wavelength of 960 nm. In the example shown in FIG. 3A, the width of the first optical waveguide layer 104 and the width of the second optical waveguide layer 106 would be designed to be 150 nm if peak efficiency were desired. In some examples, the parametric sweeping can also be used, at least in part, to determine the thickness of the first optical waveguide layer 104 and the thickness of the second optical waveguide layer 106.

FIG. 3B is a diagram showing a cross-section of the tip of another edge coupler 330. In the example shown in FIG. 3B, the tip of the edge coupler 330 includes only a lithium niobate layer (first optical waveguide layer 104). In some examples, the 330 is a fiber-to-chip or fiber-to-waveguide edge coupler that is configured to match a mode field size of an optical fiber. In the example shown in FIG. 3B, the mode profile 340 shown is for a fundamental mode (TE00) of the taper tip, which is to match that of a single-mode fiber.

As discussed above, the edge coupler 330 employs an inverse taper such that the width of the first optical waveguide layer 104 is narrowed over a length of the edge coupler 330. In some examples, the second optical waveguide layer 106 is included for at least a portion of the edge coupler 330, but the second optical waveguide layer 106 is removed over at least a majority portion of the length of the edge coupler 330. With a thinner thickness compared to the hybrid waveguide 100 since only the first optical waveguide layer 104 is retained, the edge coupler 330 can have a shorter taper length to expand the optical mode size compared to the 300 described with respect to FIG. 3A.

At the tip of the edge coupler 330, only the first optical waveguide layer 104 is retained. Similar to the techniques described above, the particular dimensions (for example, thickness and width) for the tip of the edge coupler 330 can be selected based on parametric sweeping (such as, for example, the parametric sweeping curves 350, 360 shown in FIG. 3B) of different values of the tip width to determine optimal coupling efficiency with an optical fiber.

In the example shown in FIG. 3B, particularly with the parametric sweeping curve 350, three different tip widths (80 nm, 90 nm, and 100 nm) are investigated for an operating wavelength of 480 nm, and the tip thickness is swept from 50 nm to 80 nm. The peak coupling efficiency for the parametric sweeping curve 350 is at a tip width of 90 nm and a tip thickness of 50 nm for the first optical waveguide layer 104. In the example shown in FIG. 3B, the width and thickness of the first optical waveguide layer 104 would be designed to include these values if peak efficiency were desired. In general, the thickness of the first optical waveguide layer 104 is fixed with the design of the hybrid waveguide 100, so the tip width that optimizes coupling efficiency for the particular thickness of the first optical waveguide layer 104 can be selected using the parametric sweeping curve 350 for an operating wavelength of 480 nm.

In the example shown in FIG. 3B, particularly with the parametric sweeping curve 360, three different tip widths (300 nm, 350 nm, and 400 nm) are investigated for an operating wavelength of 960 nm, and the tip thickness is swept from 60 nm to 80 nm. The peak coupling efficiency for the parametric sweeping curve 360 is at a tip width of 300 nm and a tip thickness of 70 nm for the first optical waveguide layer 104. In the example shown in FIG. 3B, the width and thickness of the first optical waveguide layer 104 would be designed to include these values if peak efficiency were desired. In general, the thickness of the first optical waveguide layer 104 is fixed with the design of the hybrid waveguide 100, so the tip width that optimizes coupling efficiency for the particular thickness of the first optical waveguide layer 104 can be selected using the parametric sweeping curve 360 for an operating wavelength of 960 nm.

For the parametric sweeping curves 320, 350, 360 shown in FIGS. 3A-3B, the coupling efficiency values are based on the assumption that a lensed single-mode optical fiber is used and the optical fiber as a Mode Field Diameter of 3 μm. As shown in the parametric sweeping curves 320, 350, 360, a coupling efficiency of above ninety percent can be achieved for an operating wavelength of 480 nm using the edge coupler 330, and a coupling efficiency of approximately ninety-five percent can be achieved for an operating wavelength of 960 nm using the edge coupler 300 or the edge coupler 330.

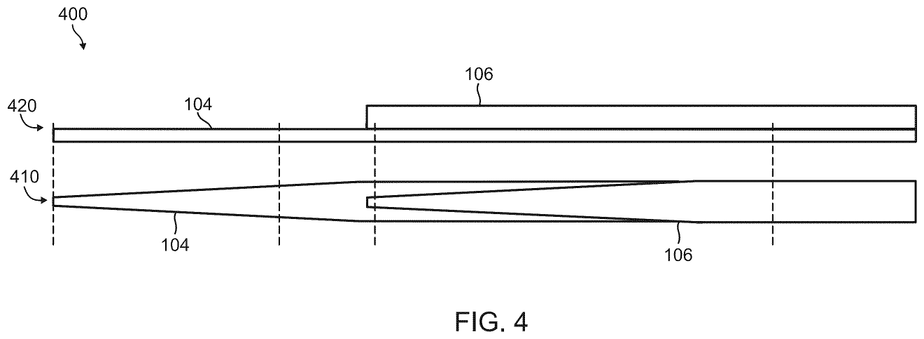

FIG. 4 is a diagram of an example spot size converter 400. In the example shown in FIG. 4, the spot size converter 400 includes the first optical waveguide layer 104 and the second optical waveguide layer 106 and is optically coupled to the hybrid waveguide 100. The spot size converter 400 is configured to convert between an optical mode size of the hybrid waveguide 100 (on the right side of FIG. 4) and the optical mode size of the optical fiber or an optical mode size of the edge coupler 300, 350 (on the left side of FIG. 4).

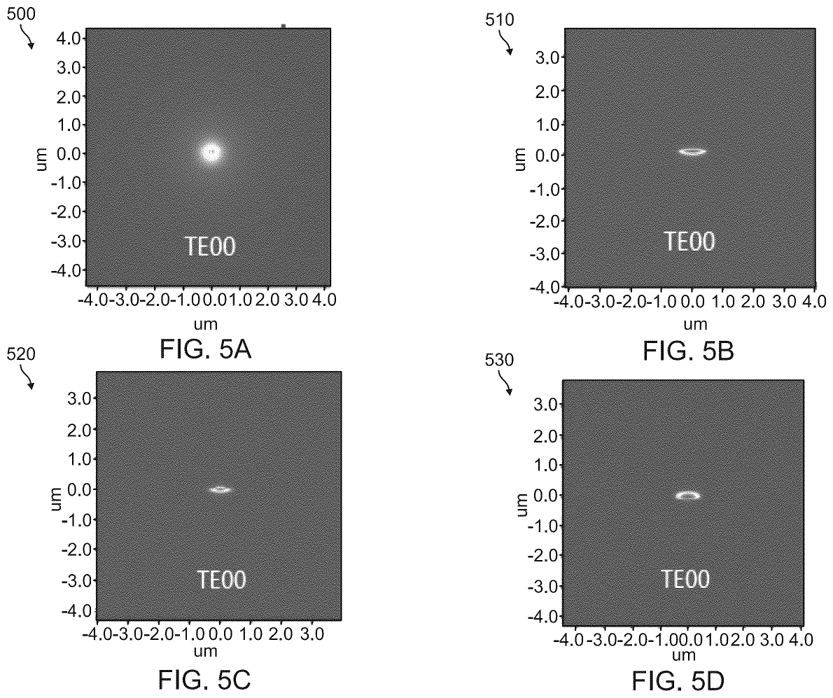

FIG. 4 includes a top view 410 of the spot size converter 400 and a side view 420 of the spot size converter 400. FIG. 4 also shows multiple sections 402, 404, 406, 408 used with the spot size converter 400 via the dashed dividing lines, and FIGS. 5A-5D illustrate the optical mode profile at each of the dashed lines. In some examples, the first section 402 and the fourth section 408 are not actually part of the spot size converter 400 and instead comprise the edge coupler 330 and the hybrid waveguide 100, respectively.

In some examples, the first section 402 of FIG. 4 is an example of the edge coupler 330 that includes a tapered first optical waveguide layer 104. In other examples, the first section on the left of FIG. 4 is separate and distinct from the edge coupler and forms part of the spot size converter 400 with a tapered first optical waveguide layer 104. In section 402, the optical mode profile is transitioned from a fundamental mode that is confined in the first optical waveguide layer 104 as shown at 510 in FIG. 5B to the optical mode profile 500 in FIG. 5A at the tip, which is similar to the optical mode profile at the tip of the edge couplers 300, 300 shown in FIGS. 3A-3B.

In some examples, the first section 402 and the second section 404 forms an adiabatic inverse taper in which the second optical waveguide layer 106 is removed and the width of the first optical waveguide layer 104 is gradually tapered from a nominal width (for example, several hundreds of nanometers and a few micrometers) down to the designed tip width for high coupling efficiency. In other examples, the multiple sections 404 forms an adiabatic inverse taper in which the second optical waveguide layer 106 is removed and the width of the first optical waveguide layer 104 is gradually tapered from a nominal width (for example, several hundreds of nanometers and a few micrometers) down to the width of an end of the edge coupler 330 that is opposite the tip. In section 404, the optical mode profile transitions from the optical mode profile 520 shown in FIG. 5C, which includes the fundamental mode that is tightly confined in the first optical waveguide layer 104 to the optical mode profile 510 shown in FIG. 5B.

In some examples, the third section 406 forms an adiabatic mode converter by tapering the second optical waveguide layer 106 over the length of the third section 406 to remove the second optical waveguide layer 106 while not tapering the first optical waveguide layer 104. In section 406, the optical mode profile transitions from the optical mode profile 530 shown in FIG. 5D, which includes the fundamental mode with a similar optical mode profile to that of the hybrid waveguide 100, to the optical mode profile 520 shown in FIG. 5C.

In some examples, the fourth section 408 is a portion of the hybrid waveguide 100. In other examples, the fourth section 408 is separate and distinct from the hybrid waveguide 100 and forms part of the spot size converter 400 that includes a similar profile to the hybrid waveguide 100.

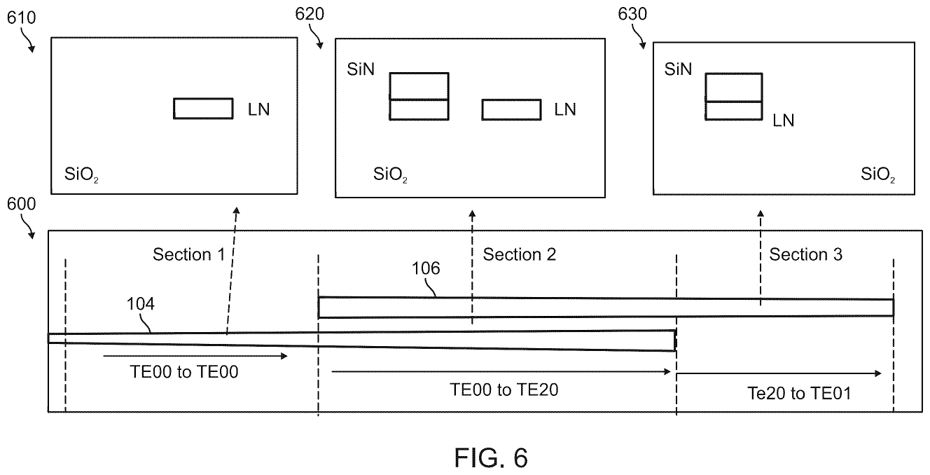

FIG. 6 is a diagram of an example mode converter 600. In the example shown in FIG. 6, the mode converter 600 includes the first optical waveguide layer 104 and the second optical waveguide layer 106. In some examples, the mode converter 600 is optically coupled to the hybrid waveguide 100. The mode converter 600 is configured to convert between a first optical mode and a second optical mode. In some examples, the mode converter 600 is configured to convert between a fundamental mode (for example, TE00) and a higher-order mode (for example, TE01).

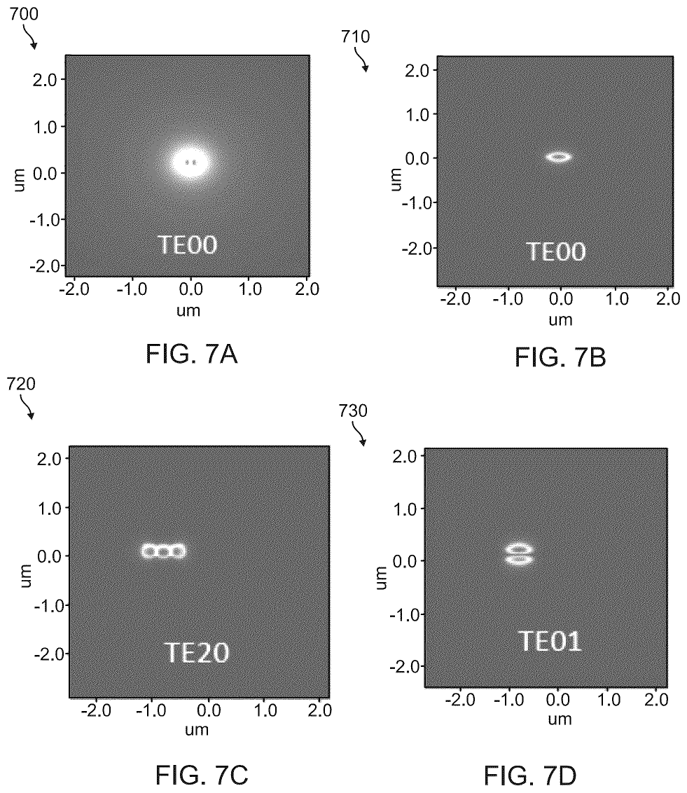

FIG. 6 includes a top view of the mode converter 600 and also shows several cross-sections 620, 630, 640 of the mode converter 600 at different sections of the mode converter 600 where the sections are separated at the dashed lines in FIG. 6. FIGS. 7A-7D illustrate the optical mode profile at each of the dashed lines. In some examples, the first section (Section 1) is not actually part of the mode converter 600 and instead comprises the edge coupler 330.

In some examples, the first section (Section 1) is a portion of the mode converter 600 and, as shown at 620, includes only the first optical waveguide layer 104. The first section (Section 1) forms an adiabatic inverse taper that includes only a tapered first optical waveguide layer 104. In the first section (Section 1), the optical mode profile is transitioned from a fundamental mode that is confined in the first optical waveguide layer 104 as shown at 710 in FIG. 7B to the optical mode profile 700 in FIG. 7A at the tip, which is similar to the optical mode profile at the tip of the edge couplers 300, 300 shown in FIGS. 3A-3B and the tip shown in FIG. 5A.

In some examples, the second section (Section 2) of the mode converter 600 forms a mode converter to transition the optical mode based on evanescent wave coupling. In the example shown in FIG. 6, the mode converter 600 includes multiple waveguide sections. The first waveguide section, shown on the right at 620, includes only the first optical waveguide layer 104 that is optically coupled to the first section (Section 1), and the second waveguide section, shown on the left at 620, includes both the first optical waveguide layer 104 and the second optical waveguide layer 106 disposed on top of the first optical waveguide layer 104. In some examples, the first waveguide section is proximate the second waveguide section (for example, within 100 nm to 200 nm). In some examples, the closeness of the first waveguide section and the second waveguide section is limited based on the fabrication resolution limits. In the second section (Section 2), the optical mode profile is transitioned from a higher-order mode (for example, TE20) in a hybrid waveguide with the optical mode profile 720 as shown in FIG. 7C to the optical mode profile 710 as shown in FIG. 7B.

In some examples, the third section (Section 3) of the mode converter 600 forms an adiabatic mode converter and includes the second optical waveguide layer 106 disposed on top of the first optical waveguide layer 104. In the third section (Section 3), the optical mode profile is transitioned from a higher-order mode (TE01) confined in the first optical waveguide layer 104 and the second optical waveguide layer 106, as shown at 730 in FIG. 7D, to the optical mode profile of another higher-order mode (for example, TE20) in the same hybrid waveguide as shown at 720 in FIG. 7C.

With the proper design of the edge coupler, spot size converter, and mode converter as discussed herein, the overall off-chip coupling efficiency is 86.5% and 95% for 480 nm and 960 nm wavelengths, respectively, for an integrated photonics chip including the hybrid waveguide 100. Therefore, the overall SHG efficiency for the particular example of the hybrid waveguide 100 discussed above is 3357% W\hat{ }(−1) cm\hat{ }(−2), which is more than one to two orders of magnitude higher than the performance of current state-of-art results with a homogenous lithium niobate waveguide.

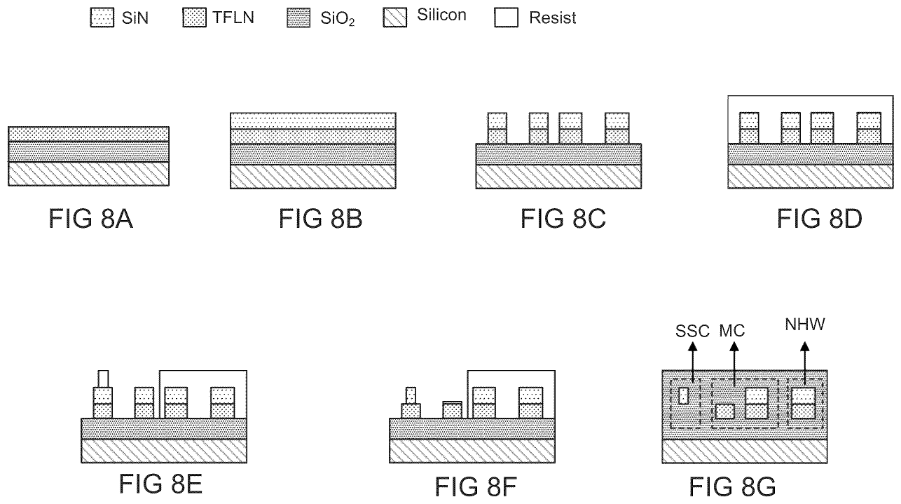

FIGS. 8A-8G illustrate a method flow an example method of manufacture of a system including a spot size converter, a mode converter, and a hybrid waveguide. As shown at FIG. 8A, the method flow starts with a bare TFLN wafer, which includes a TFLN layer disposed on silicon dioxide and silicon. As shown at FIG. 8B, the method proceeds with depositing a SiN layer on the TFLN layer. As shown at FIG. 8C, the method proceeds with patterning the SiN layer and the TFLN layer. In some examples, lithography and waveguide etching techniques are used. As shown at FIG. 8D, the method proceeds with apply a resist coating on, and surrounding, the SiN layer and the TFLN layer. As shown at FIG. 8E, the method proceeds with lithography patterning in order to strategically remove the resist coating as desired for the integrated photonics component fabrication. As shown at FIG. 8F, the method proceeds with plasma nitride etching to remove the top layer of material left after the lithography patterning. As shown in FIG. 8G, the method proceeds with silicon dioxide deposition to complete the cladding layer and the integrated photonics chip. It should be understood that the techniques used for each of the individual steps of the method shown in FIGS. 8A-8G can utilize standard fabrication techniques currently available, which makes the fabrication of the hybrid waveguide 100 and other integrated photonics chips components described herein easier than other techniques that can achieve similar nonlinear process and coupling efficiency.

By using the techniques described herein, the hybrid waveguide, which has broken spatial symmetry of the nonlinearity using multiple optical waveguide layers, significantly enhance the nonlinear process efficiency compared to homogeneous optical waveguides. Further, while state-of-the-art periodic poling (for example, PPLN) can achieve comparable nonlinear process efficiency compared to the hybrid waveguide, the hybrid waveguide is not limited to use with only longer wavelengths like periodic poling. In particular, the hybrid waveguide is not physically limited by the poling pitch like periodic poling, which is impractical or difficult to fabricate for smaller wavelengths (for example, visible wavelengths).

### EXAMPLE EMBODIMENTS

Example 1 includes a system, comprising: a hybrid waveguide including a first optical waveguide layer and a second optical waveguide layer, wherein the first optical waveguide layer is formed of a χ⁽²⁾ nonlinear optical material, wherein the second optical waveguide layer is formed of a non-χ⁽²⁾ optical material, wherein a width of the first optical waveguide layer is substantially equal to a width of the second optical waveguide layer, wherein an index of refraction of the first optical waveguide layer is within fifteen percent of an index of refraction of the second optical waveguide layer; wherein the system further comprises: an edge coupler configured to be optically coupled to an optical fiber and match a mode field size of the optical fiber, wherein the edge coupler includes at least the first optical waveguide layer, wherein the first optical waveguide layer is tapered; a spot size converter configured to convert between an optical mode size of the hybrid waveguide and the optical mode size of the optical fiber or an optical mode size of the edge coupler, wherein the spot size converter includes both the first optical waveguide layer and the second optical waveguide layer, wherein the second optical waveguide layer is tapered; and/or a mode converter configured to convert between a first optical mode and a second optical mode, wherein the mode converter includes a first section with only the first optical waveguide layer and a second section with the first optical waveguide layer and the second optical waveguide layer, wherein the first section is proximate the second section.

Example 2 includes the system of Example 1, wherein the χ⁽²⁾ nonlinear optical material is lithium niobate, aluminum nitride, or a III-V semiconductor material.

Example 3 includes the system of any of Examples 1-2, wherein the non-χ⁽²⁾ optical material is silicon nitride, tantalum pentoxide, or titanium oxide.

Example 4 includes the system of any of Examples 1-3, wherein the χ⁽²⁾ nonlinear optical material is lithium niobate, wherein the non-χ⁽²⁾ optical material is silicon nitride.

Example 5 includes the system of any of Examples 1-4, wherein the system comprises the edge coupler, wherein a tip of the edge coupler includes the first optical waveguide layer and the second optical waveguide layer, wherein the width of the first optical waveguide layer and the width of the second optical waveguide layer are tapered equally over a length of the edge coupler.

Example 6 includes the system of any of Examples 1-5, wherein the system comprises the edge coupler, wherein a tip of the edge coupler includes only the first optical waveguide layer.

Example 7 includes the system of any of Examples 1-6, wherein the system comprises the spot size converter, wherein the spot size converter is optically coupled to the hybrid waveguide.

Example 8 includes the system of any of Examples 1-7, wherein the system comprises the mode converter, wherein the mode converter is optically to the hybrid waveguide, wherein the first optical mode is a higher-order mode of the hybrid waveguide and the second optical mode is a fundamental mode.

Example 9 includes the system of any of Examples 1-8, wherein the system comprises the edge coupler, the spot size converter, and the mode converter; wherein the spot size converter is optically coupled to the edge coupler and a first end of the hybrid waveguide, wherein the spot size converter is configured to convert between the optical mode size of the edge coupler and the optical mode size of the hybrid waveguide; wherein the mode converter is optically to a second end of the hybrid waveguide, wherein the first optical mode is a higher-order mode of the hybrid waveguide and the second optical mode is a fundamental mode.

Example 10 includes a hybrid waveguide, comprising: a waveguide core including: a first optical waveguide layer, wherein the first optical waveguide layer is formed from a χ⁽²⁾ nonlinear optical material; and a second optical waveguide layer disposed on top of the first optical waveguide layer, wherein the second optical waveguide layer is formed of a non-χ⁽²⁾ optical material; and a cladding material surrounding the waveguide core; wherein a width of the first optical waveguide layer is substantially equal to a width of the second optical waveguide layer; wherein an index of refraction of the first optical waveguide layer is within fifteen percent of an index of refraction of the second optical waveguide layer.

Example 11 includes the hybrid waveguide of Example 10, wherein the χ⁽²⁾ nonlinear optical material is lithium niobate, aluminum nitride, or a III-V semiconductor material.

Example 12 includes the hybrid waveguide of any of Examples 10-11, wherein the non-χ⁽²⁾ optical material is silicon nitride, tantalum pentoxide, or titanium oxide.

Example 13 includes the hybrid waveguide of any of Examples 10-12, wherein the χ⁽²⁾ nonlinear optical material is lithium niobate, wherein the non-χ⁽²⁾ optical material is silicon nitride.

Example 14 includes a component of an integrated photonics chip, comprising: a first optical waveguide layer, wherein the first optical waveguide layer is formed from a χ⁽²⁾ nonlinear optical material; and a second optical waveguide layer disposed on top of the first optical waveguide layer, wherein the second optical waveguide layer is formed of a non-χ⁽²⁾ optical material; wherein a width of the first optical waveguide layer is substantially equal to a width of the second optical waveguide layer for at least a first portion of a length of the component; wherein an index of refraction of the first optical waveguide layer is within fifteen percent of an index of refraction of the second optical waveguide layer.

Example 15 includes the component of the integrated photonics chip of Example 14, wherein the χ⁽²⁾ nonlinear optical material is lithium niobate, wherein the non-χ⁽²⁾ optical material is silicon nitride.

Example 16 includes the component of the integrated photonics chip of any of Examples 14-15, wherein the component of the integrated photonics chip comprises a hybrid waveguide, wherein the width of the first optical waveguide layer is equal to the width of the second optical waveguide layer for all of the length of the component.

Example 17 includes the component of the integrated photonics chip of any of Examples 14-15, wherein the component of the integrated photonics chip comprises an edge coupler configured to be optically coupled to an optical fiber and match a mode field size of the optical fiber, wherein the width of the first optical waveguide layer is tapered over the length of the component, wherein the second optical waveguide layer is removed over at least a majority portion of the length of the component.

Example 18 includes the component of the integrated photonics chip of any of Examples 14-15, wherein the component of the integrated photonics chip comprises an edge coupler configured to be optically coupled to an optical fiber and match a mode field size of the optical fiber, wherein the width of the first optical waveguide layer and the width of the second optical waveguide layer are tapered equally over the length of the component.

Example 19 includes the component of the integrated photonics chip of any of Examples 14-15, wherein the component of the integrated photonics chip comprises a spot size converter configured to convert between an optical mode size of a hybrid waveguide and an optical mode size of an optical fiber or edge coupler, wherein the width of the second optical waveguide layer is tapered over a second portion of the length of the component, wherein the width of the first optical waveguide layer is not tapered over the second portion of the length of the component.

Example 20 includes the component of the integrated photonics chip of any of Examples 14-15, wherein the component of the integrated photonics chip comprises a mode converter configured to convert between a fundamental optical mode and a higher-order optical mode, wherein the mode converter includes a first section with only the first optical waveguide layer and a second section with the first optical waveguide layer and the second optical waveguide layer, wherein the first section is proximate the second section.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. A system, comprising:
a hybrid waveguide including a first optical waveguide layer and a second optical waveguide layer, wherein the first optical waveguide layer is formed of a χ⁽²⁾ nonlinear optical material, wherein the second optical waveguide layer is formed of a non-χ⁽²⁾ optical material, wherein a width of the first optical waveguide layer is substantially equal to a width of the second optical waveguide layer, wherein an index of refraction of the first optical waveguide layer is within fifteen percent of an index of refraction of the second optical waveguide layer;
wherein the system further comprises:
an edge coupler configured to be optically coupled to an optical fiber and match a mode field size of the optical fiber, wherein the edge coupler includes at least the first optical waveguide layer, wherein the first optical waveguide layer is tapered;
a spot size converter configured to convert between an optical mode size of the hybrid waveguide and the optical mode size of the optical fiber or an optical mode size of the edge coupler, wherein the spot size converter includes both the first optical waveguide layer and the second optical waveguide layer, wherein the second optical waveguide layer is tapered; and/or
a mode converter configured to convert between a first optical mode and a second optical mode, wherein the mode converter includes a first section with only the first optical waveguide layer and a second section with the first optical waveguide layer and the second optical waveguide layer, wherein the first section is proximate the second section.

2. The system of claim 1, wherein the χ⁽²⁾ nonlinear optical material is lithium niobate, aluminum nitride, or a III-V semiconductor material.

3. The system of claim 1, wherein the non-χ⁽²⁾ optical material is silicon nitride, tantalum pentoxide, or titanium oxide.

4. The system of claim 1, wherein the χ⁽²⁾ nonlinear optical material is lithium niobate, wherein the non-χ⁽²⁾ optical material is silicon nitride.

5. The system of claim 1, wherein the system comprises the edge coupler, wherein a tip of the edge coupler includes the first optical waveguide layer and the second optical waveguide layer, wherein the width of the first optical waveguide layer and the width of the second optical waveguide layer are tapered equally over a length of the edge coupler.

6. The system of claim 1, wherein the system comprises the edge coupler, wherein a tip of the edge coupler includes only the first optical waveguide layer.

7. The system of claim 1, wherein the system comprises the spot size converter, wherein the spot size converter is optically coupled to the hybrid waveguide.

8. The system of claim 1, wherein the system comprises the mode converter, wherein the mode converter is optically to the hybrid waveguide, wherein the first optical mode is a higher-order mode of the hybrid waveguide and the second optical mode is a fundamental mode.

9. The system of claim 1, wherein the system comprises the edge coupler, the spot size converter, and the mode converter;
wherein the spot size converter is optically coupled to the edge coupler and a first end of the hybrid waveguide, wherein the spot size converter is configured to convert between the optical mode size of the edge coupler and the optical mode size of the hybrid waveguide;
wherein the mode converter is optically to a second end of the hybrid waveguide, wherein the first optical mode is a higher-order mode of the hybrid waveguide and the second optical mode is a fundamental mode.

10. A hybrid waveguide, comprising:
a waveguide core including:
a first optical waveguide layer, wherein the first optical waveguide layer is formed from a χ⁽²⁾ nonlinear optical material; and
a second optical waveguide layer disposed on top of the first optical waveguide layer, wherein the second optical waveguide layer is formed of a non-χ⁽²⁾ optical material; and
a cladding material surrounding the waveguide core;
wherein a width of the first optical waveguide layer is substantially equal to a width of the second optical waveguide layer;
wherein an index of refraction of the first optical waveguide layer is within fifteen percent of an index of refraction of the second optical waveguide layer.

11. The hybrid waveguide of claim 10, wherein the χ⁽²⁾ nonlinear optical material is lithium niobate, aluminum nitride, or a III-V semiconductor material.

12. The hybrid waveguide of claim 10, wherein the non-χ⁽²⁾ optical material is silicon nitride, tantalum pentoxide, or titanium oxide.

13. The hybrid waveguide of claim 10, wherein the χ⁽²⁾ nonlinear optical material is lithium niobate, wherein the non-χ⁽²⁾ optical material is silicon nitride.

14. A component of an integrated photonics chip, comprising:
a first optical waveguide layer, wherein the first optical waveguide layer is formed from a χ⁽²⁾ nonlinear optical material; and
a second optical waveguide layer disposed on top of the first optical waveguide layer, wherein the second optical waveguide layer is formed of a non-χ⁽²⁾ optical material;
wherein a width of the first optical waveguide layer is substantially equal to a width of the second optical waveguide layer for at least a first portion of a length of the component;
wherein an index of refraction of the first optical waveguide layer is within fifteen percent of an index of refraction of the second optical waveguide layer.

15. The component of the integrated photonics chip of claim 14, wherein the χ⁽²⁾ nonlinear optical material is lithium niobate, wherein the non-χ⁽²⁾ optical material is silicon nitride.

16. The component of the integrated photonics chip of claim 14, wherein the component of the integrated photonics chip comprises a hybrid waveguide, wherein the width of the first optical waveguide layer is equal to the width of the second optical waveguide layer for all of the length of the component.

17. The component of the integrated photonics chip of claim 14, wherein the component of the integrated photonics chip comprises an edge coupler configured to be optically coupled to an optical fiber and match a mode field size of the optical fiber, wherein the width of the first optical waveguide layer is tapered over the length of the component, wherein the second optical waveguide layer is removed over at least a majority portion of the length of the component.

18. The component of the integrated photonics chip of claim 14, wherein the component of the integrated photonics chip comprises an edge coupler configured to be optically coupled to an optical fiber and match a mode field size of the optical fiber, wherein the width of the first optical waveguide layer and the width of the second optical waveguide layer are tapered equally over the length of the component.

19. The component of the integrated photonics chip of claim 14, wherein the component of the integrated photonics chip comprises a spot size converter configured to convert between an optical mode size of a hybrid waveguide and an optical mode size of an optical fiber or edge coupler, wherein the width of the second optical waveguide layer is tapered over a second portion of the length of the component, wherein the width of the first optical waveguide layer is not tapered over the second portion of the length of the component.

20. The component of the integrated photonics chip of claim 14, wherein the component of the integrated photonics chip comprises a mode converter configured to convert between a fundamental optical mode and a higher-order optical mode, wherein the mode converter includes a first section with only the first optical waveguide layer and a second section with the first optical waveguide layer and the second optical waveguide layer, wherein the first section is proximate the second section.
